(19) United States
(12) Patent Application Publication
(10) Pub. No.: US 2025/0005602 A1
(43) Pub. Date: Jan. 2, 2025

(54) INTEGRATING TEXTUAL AND GRAPHICAL ANALYSIS TO DETECT INTERNET HUMAN TRAFFICKING

(71) Applicant: NETSPARK LTD, Givat Shmuel (IL)

(72) Inventors: Elyasaf Korenwaitz, Elon Moreh (IL); Zvi Bazak, Jerusalem (IL); Matanya Ofan, Yitzhar (IL)

(73) Assignee: NETSPARK LTD, Givat Shmuel (IL)

(21) Appl. No.: 18/707,586

(22) PCT Filed: Dec. 26, 2022
(86) PCT No.: PCT/IL2022/051387

§ 371 Date: May 5, 2024

Related U.S. Application Data
(60) Provisional application No. 63/300,057, filed on Jan. 17, 2022.

(51) Int. Cl. G06Q 30/018; G06V 10/764; G06V 30/19

(52) U.S. Cl. CPC G06Q 30/0185; G06V 10/764; G06V 30/19173

(57) ABSTRACT

a method and/or computer program to analyze pictures and/or texts of an entity (for example a presentation such as a web-site on an Internet platform and/or a user of a chat application etc.) to determine if the entity includes human trafficking and/or other sought (e.g., undesirable) content and/or activities. A platform may be configured to detect signs that arouses suspicion. For example, the system may analyze both media and text and the relationship between text and media. an anachronistic element in a site. For example, text of a site may appear to advertise a certain product (e.g., childcare), but be set up in such a way and/or include media (e.g., sexually suggestive pictures) that would not attract and/or might deter a legitimate consumer from using the site.

### RELATED APPLICATION/S

This application claims the benefit of priority under 35 USC § 119 (e) of U.S. Provisional Patent Application No. 63/300,057 filed 17 Jan. 2022, the contents of which are incorporated herein by reference in their entirety.

### FIELD AND BACKGROUND OF THE INVENTION

The present invention, in some embodiments thereof, relates to a method for detecting human trafficking and, more particularly, but not exclusively a method for analyzing and/or detecting human trafficking on internet platforms, (i.e., internet sites and/or social media platforms and/or chat platforms).

U.S. Pat. No. 9,942,250 appears to disclose, “Electronic appliances, computer-implemented systems, non-transitory media, and methods are provided to identify risky network activities using intelligent algorithms. The appliances, systems, media, and methods enable rapid detection of risky activities.”

US Published patent application No. 20180130061 appears to disclose, “An example merchant fraud system may include an automated system for collecting contextual relationship information, plus a routine for analyzing additional data related to sanctions. The system may also include an automated analysis summary routine for creating condensed information subsets or graphlets containing information about sanction entities, some of which can be entities themselves, organized in a data retrieval system, such that an automated relationship examination system can check data from transactions and automatically identify and flag potentially suspect relationship aspects. The system may issue a fraud warning and may review a flagged transaction cluster, accepting transactions when transaction cluster items do not contain links to a known bad entity. Based on a hit with a suspect entity, the breadth of the examined co-related items may be expanded, and if that expansion results in one or more suspect connections, a transaction is rejected and sent for further review.”

U.S. Pat. No. 8,924,538 appears to disclose, “In a computer-implemented method of computer usage monitoring, at least one of the following is electronically monitored on a computing device without reference to an electronically produced visual image: one or more of keywords or phrases input into an application; a presence of one or more of the keywords or phrases in a file; or the launching of one or more applications or programs. Responsive to the input of one or more of the listed keywords or phrases into an application running on the computing device, the presence of one or more of the listed keywords or phrases in a file on the computing device, or the launching of one or more of the listed applications or programs on the computing device, an electronic form of at least one visual image produced by the computing device is recorded and electronically dispatching to another computing device.

### SUMMARY OF THE INVENTION

According to an aspect of some embodiments of the invention, there is provided a method for categorizing an entity with respect to a sought content including: analyzing text in the entity to produce a text analysis; analyzing media in the entity to produce a media analysis; correlating the text analysis and the media analysis; and classifying whether the entity includes the sought content based the correlating.

According to some embodiments of the invention, the sought content is human trafficking.

According to some embodiments of the invention, the classifying is based on an artificial intelligence routine.

According to some embodiments of the invention, the artificial intelligence routine include natural language analysis.

According to some embodiments of the invention, the method further includes analyzing text of includes of a second entity classifying the second entity as unlikely to include the sought content based on the text analysis without preforming the correlating.

According to some embodiments of the invention, the correlating includes correlating a portion of the text in the entity with a media associated with the portion of the text.

According to some embodiments of the invention, a site is identified as suspicious due to a presence of anachronistic material.

According to some embodiments of the invention, the anachronistic material includes geographically anachronistic material.

According to some embodiments of the invention, the anachronistic material includes climatically anachronistic material.

According to some embodiments of the invention, the anachronistic material includes inappropriate dress.

According to some embodiments of the invention, the anachronistic material includes inappropriate aged people.

According to some embodiments of the invention, the anachronistic material includes inappropriate groupings of people.

According to some embodiments of the invention, an entity is identified as suspicious due to lacking an expected element.

According to some embodiments of the invention, an entity is cleared of suspicion due to lacking an expected element.

According to some embodiments of the invention, an entity is identified as suspicious due to lacking an expected forward link.

According to some embodiments of the invention, an entity is cleared of suspicion due to lacking an expected forward link.

According to some embodiments of the invention, an entity is identified as suspicious due to lacking an expected backward link.

According to some embodiments of the invention, the analyzing accounts for a hierarchy of the entity.

According to some embodiments of the invention, the entity includes a chat user.

According to some embodiments of the invention, the entity includes a website.

According to some embodiments of the invention, the entity includes a web page.

According to some embodiments of the invention, the entity includes a chat application.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

As will be appreciated by one skilled in the art, some embodiments of the present invention may be embodied as a system, method or computer program product. Accordingly, some embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, some embodiments of the present invention may take the form of a computer program product embodied in one or more computer readable medium(s) having computer readable program code embodied thereon. Implementation of the method and/or system of some embodiments of the invention can involve performing and/or completing selected tasks manually, automatically, or a combination thereof. Moreover, according to actual instrumentation and equipment of some embodiments of the method and/or system of the invention, several selected tasks could be implemented by hardware, by software or by firmware and/or by a combination thereof, e.g., using an operating system.

For example, hardware for performing selected tasks according to some embodiments of the invention could be implemented as a chip or a circuit. As software, selected tasks according to some embodiments of the invention could be implemented as a plurality of software instructions being executed by a computer using any suitable operating system. In an exemplary embodiment of the invention, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

Any combination of one or more computer readable medium(s) may be utilized for some embodiments of the invention. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium and/or data used thereby may be transmitted using any appropriate medium, including but not limited to wireless, wireline, optical fiber cable, RF, etc., or any suitable combination of the foregoing.

Computer program code for carrying out operations for some embodiments of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) and/or a mesh network (mesh net, enmesh) and/or a wide area network (WAN), or the connection may be made to an external computer (for example, through the Internet using an Internet Service Provider).

Some embodiments of the present invention may be described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Some of the methods described herein are generally designed only for use by a computer, and may not be feasible or practical for performing purely manually, by a human expert. A human expert who wanted to manually perform similar tasks might be expected to use completely different methods, e.g., making use of expert knowledge and/or the pattern recognition capabilities of the human brain, which would be vastly more efficient than manually going through the steps of the methods described herein.

Data and/or program code may be accessed and/or shared over a network, for example the Internet. For example, data may be shared and/or accessed using a social network. A processor may include remote processing capabilities for example available over a network (e.g., the Internet). For example, resources may be accessed via cloud computing. The term “cloud computing” refers to the use of computational resources that are available remotely over a public network, such as the internet, and that may be provided for example at a low cost and/or on an hourly basis. Any virtual or physical computer that is in electronic communication with such a public network could potentially be available as a computational resource. To provide computational resources via the cloud network on a secure basis, computers that access the cloud network may employ standard security encryption protocols such as SSL and PGP, which are well known in the industry.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

FIGS. 1A to 1D are flow chart illustrations of a method of classifying an entity in accordance with embodiments of the current invention;

FIG. 2A is a block diagram of a system for classifying an entity in accordance with an embodiment of the current invention;

FIG. 2B is an illustration of a system in accordance with an embodiment of the current invention;

FIG. 3A is a schematic illustration illustrating an embodiment of the current invention;

FIGS. 3B and 3C illustrate exemplary sites where text and media may be used to identify illegal activities in accordance with an embodiment of the current invention;

FIG. 4 is a schematic diagram illustrating a social media in accordance with an embodiment of the current invention;

FIG. 5A is a schematic diagram illustrating an embodiment of the current invention;

FIGS. 5B and 5C illustrate chats in social networks in accordance with an embodiment of the current invention;

FIG. 6 is a flow chart illustrating an embodiment of the current invention; and

FIG. 7 is a block diagram illustrating data flow in an embodiment of the current invention.

### DESCRIPTION OF SPECIFIC EMBODIMENTS OF THE INVENTION

The present invention, in some embodiments thereof, relates to a method for detecting human trafficking and, more particularly, but not exclusively a method for analyzing and/or detecting human trafficking on internet platforms, (i.e., internet sites and/or social media platforms, and/or chat platforms).

### Overview

An aspect of some embodiments of the current invention relates to a method and/or computer program to analyze pictures and/or texts of an entity (for example a presentation such as a web-site on an Internet platform and/or a user of a chat application etc.) to determine if the entity includes human trafficking and/or other sought (e.g., undesirable) content and/or activities. There may be web entities that may conduct immoral and/or illegal activities, such as human trafficking and/or other activities that may be immoral and/or illegal. Law enforcement agencies and/or other organizations may wish to find such sites in order to close them down and/or prosecute perpetrators. Service providers such as Internet Service Providers (ISP) and/or social network platforms may want to recognize and/or remove perpetrators from their platforms.

Alternatively or additionally, law enforcement and/or others may desire to analyze sites by means of a computer program. For example, there may be web platforms that may have aroused suspicion and/or may have been reported. Alternatively, or additionally there may be various web platforms that a law enforcement and/or an advocacy organization may wish to analyze and/or search for suspicious material. For example, there may be legal and/or judicial permission as part of an investigation etc. there may be programs and/or methods that search and/or analyze semantic signs (e.g., searching for text that is characteristic of human trafficking sites), For example, it is desirable to have high sensitivity (e.g., it should identify a large portion of the sites having the sought content for example more than 10% and/or more than 30% and/or more than 50% and/or more than 70% and/or more than 90%) and/or high specificity (e.g., the should be few sites identified that do not actually include the sought content, for example, less than 10% and/or less than 30% and/or less than 50% and/or less than 70% of the sites identified should be without the content alternatively or additionally, a site not having the sought content should be unlikely to be identified falsely as containing the content, for example, less than 10% of the sites without the content should be identified as having the content and/or less than 5% and/or less than 1% and/or less than 0.1% and/or less than 0.01%). For example, a program should reliably differentiate a web platform of human trafficking (and/or other immoral and/or illegal activities) from web platforms performing legal activity and/or legal type platforms (for example escort sights and/or dating sights and/or paid companion sites etc.).

The current inventor in extensive interviews with law enforcement officials came to understand that suppliers of illegal activities (especially human trafficking, pedophilia, etc.) seek customers on the Internet. According to Law enforcement officials, these sites are on the one hand concealed by appearing as legitimate websites, but on the other hand include content that are intended to tip off potential clients that what they want can be found here. People experienced in the field (either seeking criminal activity or fighting criminal activity can “smell” such a site, but it has generally been very difficult to program automated systems to recognize such activity.

The current inventor recognized that one of the signs that arouses suspicion is an anachronistic element in a site. For example, a site may pretend to sell a certain product, but be set up in such a way and/or include content that would not attract and/or might deter a legitimate consumer from using the site. For example, there may be content that would be put off a legitimate consumer and attract an illicit customer and/or there may be different products sold together that don't make sense (for example, a childcare site may also include a section selling women's lingerie and/or include alluring images; for example, an escort service in a wealthy country may include a pictures of young woman in third world countries; for example, a site advertising vacations to Thailand may include language that picks up searches for pornography and include pictures of Asian women in hotels in Western countries; for example, a travel site might include pictures of women sunbathing in a page advertising a ski vacations; for example, a site may advertise vacations to beach resorts in exotic poor countries and violent toys [e.g., hand cuffs, cap guns, Darth Vadar costumes] each of which wouldn't raise alarms by itself, but together may be alarming; for example, a social network group for a childcare institution may include mostly users who are single men and/or may include content and/or advertising that appeals to single men).

Some algorithms search for textual content and/or image content that is characteristic to a sought site (e.g., illegal activities). Such algorithms are unlikely to pick up the “rotten smell” in “Denmark” of such anachronistic combinations of legitimate content. In some embodiments, the current invention will search different elements of a web site and/or a web page and/or associated elements (e.g., a picture and the caption of that picture) for signs of a particular function and/or activity e.g., for example, signs of illegal activity, signs of human trafficking etc.

In some embodiments, the hierarchy of an entity (e.g., a web site, a web page, a HTML document) may be used in analysis for illicit activity. For example, a title of a page and/or a header of a section may be used to determine if material of the page and/or section is fitting and/or anachronistic to the stated title. For example, figure captions and associated figures may be analyzed with a higher sensitivity to anachronistic material than un related text and/or figures. For example, text in a list may be treated differently than text in a normal paragraph. For example, questions and answers may be analyzed with a higher sensitivity to anachronistic material than un related text.

An embodiment of the current invention may include a method and/or program for analyzing text (e.g., semantic qualities of the text and/or code language etc.) and/or may include a method and/or program for analyzing images and/or may include a method for analyzing image in combination with text and/or collaborations of text contents and/or picture contents. For example, an embodiment may include a method and/or program for detecting human trafficking by combination of graphic and textual data and/or more specifically by the combination of certain text (e.g., characteristic of escort hiring) and certain characteristic images. (e.g., mildly pornographic images) and/or other analysis of integrated text and media data. Optionally, the analysis may be done using Artificial Intelligence (AI), statistical tools and/or correlations, Natural Language Processing (NLP), Neural Networks, semantic analysis.

Additionally, or alternatively, an embodiment may include method and/or program for analyzing audio and/or video content. Additionally, or alternatively, an embodiment may include a method of searching and/or analyzing computer networks, and/or mobile devices (file storage, and/or applications etc.) and/or physical material (e.g., magazines and/or fliers etc.) and/or other platforms.

### EXEMPLARY EMBODIMENTS

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

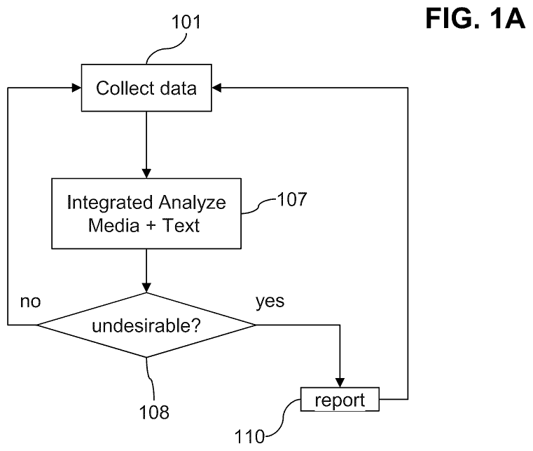

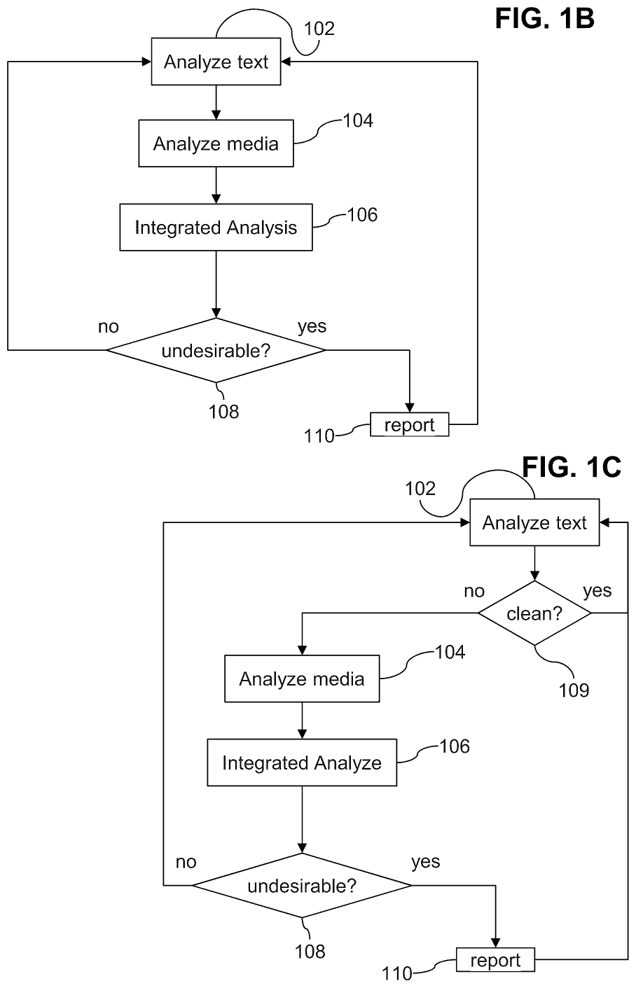

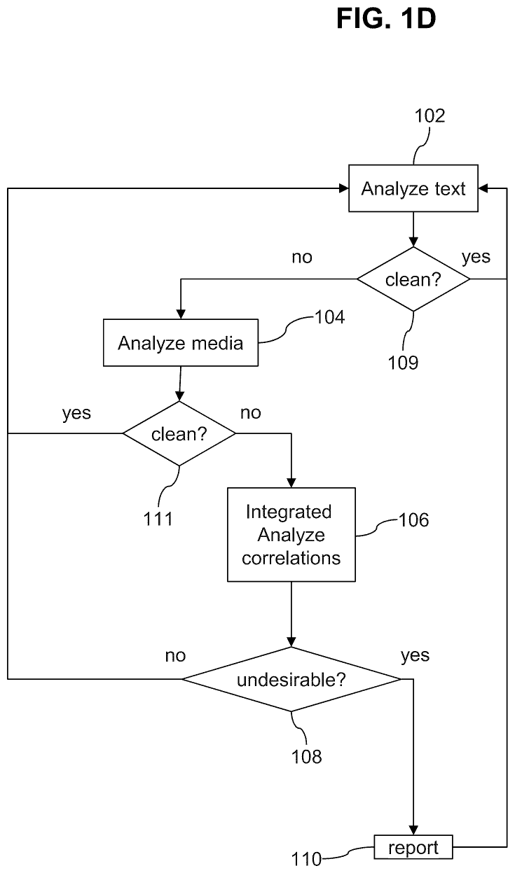

FIGS. 1A to 1D are flow chart illustrations of a method of classifying an entity in accordance with embodiments of the current invention. In some embodiments of the current invention, raw data from a website (e.g., text and/or media data and/or data about interconnections between data) are collected 101 and/or fed to a routine that analysis. Collecting data may include selecting a website to analyze. For example, a website may be selected based on external signals, such as having been referenced in suspicious sites and/or computers and/or chats. Alternatively or additionally, there may be internal signs that trigger analysis of a signs that a site may be of interest (e.g., a title and/or the presence or absence of certain elements). Data may be taken from and/or about the web site, for example, may include the text and/or media and/or interrelationships between elements. The system may be used to scan a network (e.g., the Internet) for various sorts of sites (e.g., human trafficking). For example, data from the site may be analyzed 107 for the sought content. Elements from the site (e.g., text and/or images) may be analyzed 107 and/or the relationships between elements may be analyzed (are two images found on the same site and/or the same page, is a particular text associated with another text and/or image). Based on the content and/or interrelations, the routine may identify 108 a suspicious site (e.g., a site likely to have an undesirable element such as criminal activity such as human trafficking). When a suspicious site identified 108, it is optionally reported. Optionally, the system goes on to test a further site. If the site is not identified as suspicious (e.g., including suspicious content), the system may go on to test a new site. Optionally, record keeping (e.g., via hash tags and/or lists) may be kept to avoid reanalyzing the same sites over again.

In some embodiments, separate text analysis 102 and/or media analysis 104 will be performed along with and/or separately and/or integrated with the integrated analysis 106 of text and media. For example, as illustrated in FIG. 1B, text and/or media may be analyzed 102, 104 with various tools giving results that fed to the integrated analysis engine. For example, text strings may be found and/or converted into a score and/or statistics about the prevalence of various signs in the text. For example, media may be analyzed 104 using and/or pre-processed (for example using tools describe herein below) to reduce the size of data and/or to produce various statistics and/or measures that are analyzed (for example by an AI routine) to identify 108 sought after content.

In some embodiments, before use of integrated analysis, other methods are used to make a coarse identification and/or elimination 109 of some entities (for example a chat user and/or a presentation such as a web site etc.) prior to integrated analysis of a portion of the sites. For example, as illustrated in FIGS. 1C and 1D), when text analysis 102 and/or media analysis 104 may be enough to categorize and/or eliminate 109, 111 an entity (e.g., ban, report to authorities, investigate, blacklist, prosecute etc.). Optionally, the site may be categorized without using integrated analysis 106. For example, the routine may sequentially apply more and more resource expensive routines. For example, if a site can be identified as suspicious and/or eliminated 109 from suspicion by simple text analysis 102 then the site may be reported 110 and/or discarded without requiring more expensive Thus, the cheaper forms of analysis (e.g., text analysis 102 and/or media analysis 104) may be used avoiding the use of the more expensive forms of analysis (e.g., integrated analysis 106 and/or AI).

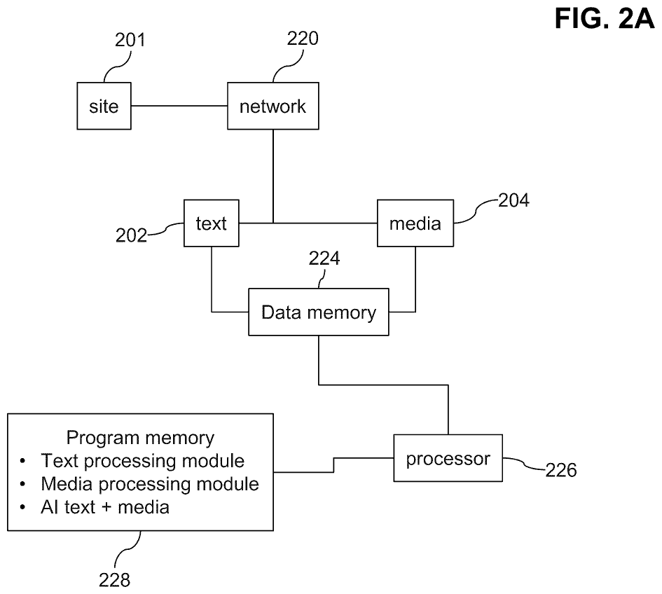

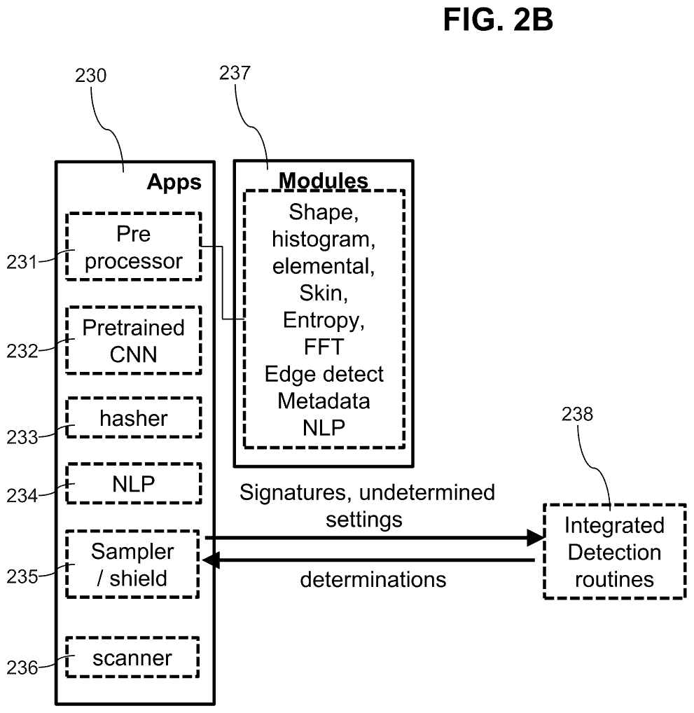

FIG. 2A is a block diagram of a system for classifying an entity in accordance with an embodiment of the current invention. In some embodiments, text 202 and/or media 204 from an entity (e.g., a web site 201 may be stored in a memory 224 and/or preprocessed by a processor 226). The processor 226 and/or another processor may be used to analyze the data for the presence of content that is sought and/or signs of activities that are sought (e.g., human trafficking to report to authorities and/or block). Optionally, preprocessing routines and/or analysis routines are stored on a program memory. In some embodiments, routines are stored in a memory 228 and/or supplied for text processing and/or media processing and/or integrated processing.

FIG. 2B is an illustration of a system in accordance with an embodiment of the current invention. In some embodiments, software 230 for sampling, monitoring and/or analyzing content is stored in a memory (e.g., a local memory, a dedicated memory, cloud storage etc.). Additionally or alternatively, dedicated hardware and/or parallel hardware may be used to pre-processing and/or content analysis functions. For example, a sampling routine and/or a module (for example a preprocessing module 231) and/or on a separate hardware device for example, a FPGA and ASIC and/or a SOC.

In some embodiments, software for sampling, monitoring and/or analyzing content is stored in a local memory and/or accessed through a local program. For example, a program that is anyway accessing the data. In some embodiments data may be sorted and/or routines may be performed on dedicated hardware and dedicated resources. Optionally, the software may include a sampler/shield routine 235 that samples and/or categorizes (e.g., parses) content and/or relationships between content items (for example text, images and/or videos and/or parts of an entity) and/or sends data for analysis (for example the data may include the content and/or a portion thereof and/or information about the content and/or information on relationship between various pieces of content). For example, sampler/shield 235 may include instructions that sample content differently based on active and/or background applications, regions of a site, heading in an html document and/or regions of storage. The sample may be configured to efficiently screen undesired sites while reducing the requirement for system resources for analysis. Optionally, the software may include a preprocessor 231 that screens content quickly and/or recognizes items that are likely candidates to include and/or indicate undesirable content. Alternatively or additionally, the preprocessor 231 may reduce content for example, to make it easier to analyze. For example, a preprocessor 231 may select frames from a video and/or reduce the image density and/or remove portions of an image before sending it for further analysis.

In some embodiments, some or all of the functions and/or data may be stored and/or performed by dedicated hardware. Data and/or applications may be stored on dedicated memory. Alternatively or additionally, some or all of the applications and/or data may be stored on removable media and/or network 220 accessible memory. In some embodiments, user data may include personalized instructions that define how strictly to sample and/or analyze content and/or how many resources to use in the analysis and/or when to send data for further analysis and/or how to act when objectionable content is found what to scan. A scanner 236 routine may be supplied to crawl the web and/or scan incoming code and supply it to the sampler.

In some embodiments, a hasher 233 (e.g., a hash function) may be used to recognize previously identified undesirable content and/or sites for example based on a signature. Alternatively or additionally, the hasher 233 may derive a signature from content that is recognized as undesirable. Optionally, signatures will be uploaded and/or downloaded to and/or from an external server. For example, signatures of undesirable content found on the user device may be uploaded to the server and/or sent to other devices to help identify the content if it finds its way there (e.g., over the Internet and/or social networks). For example, signatures of undesirable content found on the other devices may be downloaded on to the user device to help identify the content if it finds its way to the user device. Optionally the hasher 233 and/or signatures for identifying previously recognized undesirable content and/or for generating signatures for quick recognition of newly recognized undesirable content and/or for marking already scanned sites and/or content are supplied.

In some embodiments, an AI routine (for example, CNN routines 232) is used for recognizing undesired content. Optionally, the routines are pretrained. The software and/or data may be periodically updated. For example, data may be passed between the processor and/or an internal memory 238 and/or an external database and/or a remote processor. Optionally, the analysis may be done using Artificial Intelligence (AI), statistical tools and/or correlations, Natural Language Processing (NLP) 234, Neural Networks, semantic analysis.

In some embodiments a monitoring application may run on a mobile device. Optionally, the application may be a standard and/or self-contained application. Alternatively or additionally, the application may exist as an add-on (e.g., an SDK add-on) to an existing application (for example a social network and/or messenger application (e.g., Facebook and/or WhatsApp)). Optionally, the application may run on a main processor and/or on a parallel processor (e.g., dedicated hardware) and/or on a server.

In some embodiments, software may include one or more modules 237. For example, a module 237 may be configured to perform a repetitive task efficiently. For example, modules may include computing a General Classification Features (GCF). For example, the GCF may assign a value to a media object and/or each frame of a collection of key frames of a video. Duplicate data may be compared using a GCF value between objects. Optionally duplicate data are operationally defined as objects having a GCF value similar to at least one other object. For example, duplicated data may be removed from the analysis. In some embodiments, preprocessing may include a white balance correction module, a gamma correction module, an edge enhancement module, a JPEG compression module, an FFT module, an edge detection module, a pattern extraction module, a Fourier-Mellin module, a texture classifier module, a color histogram module, motion detection module, a feature recognition module, and/or a skin tone detection module (for example to grade a percentage of skin tones in an image).

FIG. 2B is an illustration of data flow in accordance with an embodiment of the current invention. In some embodiments, a server and/or centralized database will be in communication with a dedicated device. For example, the server may send software updates and/or signatures of undesirable content. In some, embodiments, detection routing may analyze raw data from sites and/or preprocessed data and/or the results of text and/or media analysis for example, text data and/or media data and/or the results of text analysis and/or the results of image analysis may be analyzed in an integrated fashion.

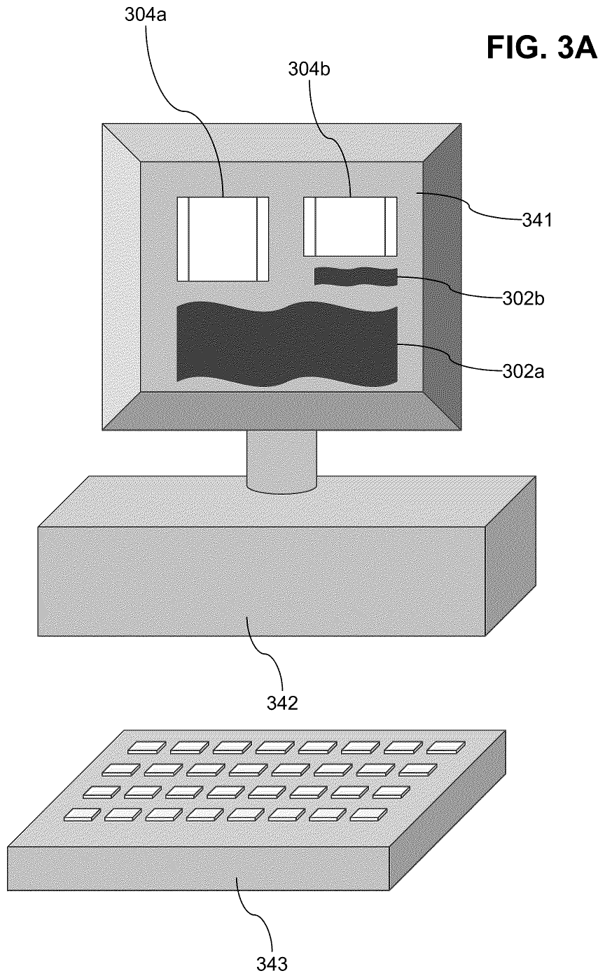

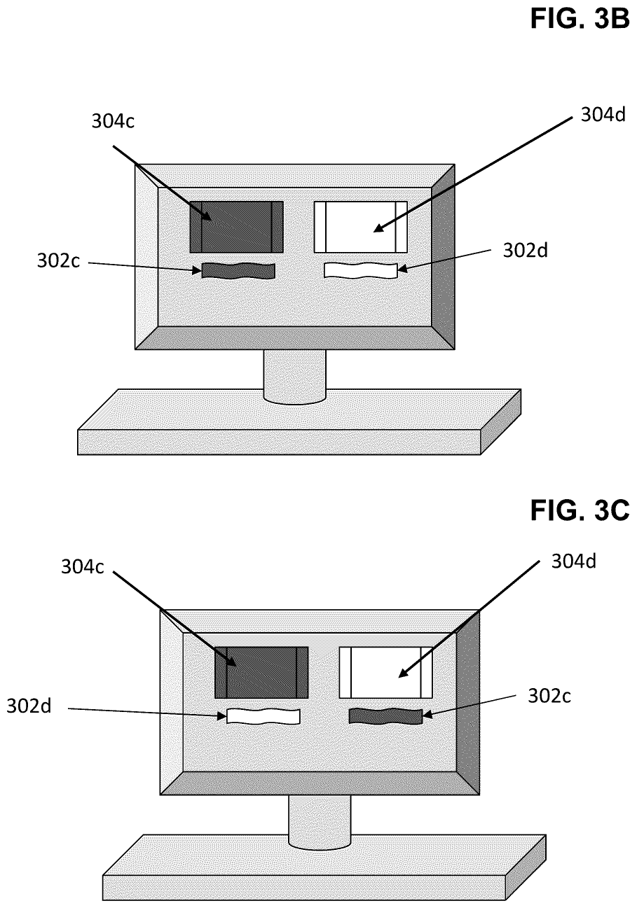

FIG. 3A is a schematic illustration illustrating an embodiment of the current invention. Some embodiments of the current invention include system to detect content for example illegal web activity for example human trafficking. For example, the system may include a processor 342 running a program for analyzing combinations of text content and/or media content (e.g., image content and/or audio content and/or video content). The system optionally includes an input interface 343 (e.g., a keyboard) and/or an output interface 341 (e.g., a screen). For example, the input interface may be used to the controlling the processor and/or showing the text, the images and/or output of the processor. For example, software, hardware and/or firmware to instruct the processor to analyze various videos and/or pictures in combination with the various texts on a web platform. An embodiment may include a method and/or program for recognizing human trafficking by correlating textual and graphical data and/or other types of media.

In some embodiments, one or more combinations of textual characteristics and/or characteristic image content may be specific to an illegal activity and/or characteristic of a large portion of sites involved in an illegal activity. For example, human trafficking detection method and/or program may identify a human trafficking site containing a combination of text that on its own would not arouse suspicion (for example, text that is characteristic of escorts services and/or dating sites) in combination with graphics that on their own would not arouse suspicion (e.g., borderline pornographic and/or but not explicit pornography). This combination may be extremely rare in legitimate sites and/or may be a warning sign that further investigation is needed and/or may be used to identify human trafficking sites.

An embodiment may include algorithms and/or methods for identifying when an entity (e.g., a presentation such as a web platform and/or a web site) is likely to contain a human trafficking site and/or other immoral and/or illegal content. Alternatively or additionally, an embodiment may include a method and/or a program for searching various sights and/or determining activating a warning sign and/or reporting for additional investigation sites likely to include illegal and/or immoral content (e.g., human trafficking). For example, a program may check text and/or pictures and/or other media for patterns that arouses suspicion. For example, a program may determine that a site with including a predetermined quantity of characteristic media and/or characteristic text is suspicious. Additionally or alternatively, the program may determine that a site including a certain combination of text and media content is suspicious. Additionally or alternatively, the program may determine that a site including a certain combination of text and media content that are associated with each other media 304b (e.g., a picture) and an associated caption 302b and/or a text with an associated picture and/or text of link with an associated media and/or a text and medial associated under a single heading (e.g., a html heading) and/or text and a media that are close to each other inside an entity). For example, when the text 302a and media 304a are not associated in a specific way, then that combination may be treated differently from media 304b and text 302b that are associated. For example, the combination of certain associated media 304b and text 302b may trigger a report of suspicious content whereas the same text 302a and media 304a when non-associated may not be a problem and/or may not arouse suspicion. Alternatively or additionally, the combination of certain non-associated media 304a and text 302a may trigger a report of suspicious content whereas the same text 302b and a media 304b (e.g., an image) when associated may not be a problem and/or may not arouse suspicion. Association may include being on the same page, the text being in a heading with the image, the text being a caption to the image. For example, a program may check which details are described about pictures on the page and/or may analyze if they arouse suspicion. For example, if a page includes media 304a (e.g., images and/or videos) that are borderline but not grossly pornographic and/or if the same site contains typical textual content 302a such as sale, escort, ethnicity, nationality, vague identification. Alternatively or additionally, the system may look for associations between text 302b and/or media 304b between linked entities and/or between an entity and an associated communication (for example, a comment posted to a site and/or a mention of the site on a social media and/or a mention of the site in an advertisement and/or a media on a second site where the subject site is advertised). For example, the system may look for a text and/or medial and/or associations between a subject site and a link to the subject site from a separate site associated with a link to the subject.

An exemplary site includes two examples of media 304a, 304b. One media 304b is associated with text 302b on the page (e.g., a picture and a caption). The other text 302a is, for example, not associated with a specific media. The other medial 304a is not associated with a specific text. In some embodiments, text and/or media on a single site may be correlated together without reference to specific associations.

FIG. 3B illustrates an exemplary site where text 302c indicating human trafficking is specifically associated with media 304c associated with human trafficking and where text 302d less indicating human trafficking is specifically associated with media 304d less associated with human trafficking. FIG. 3C illustrates an exemplary site containing media 304c indicating human trafficking and also text 302c indicating human trafficking that are not specifically associated. In some embodiments, a program may identify both examples as suspected of including human trafficking. Alternatively or additionally, the web site of FIG. 3B may be identified as suspicious of containing human trafficking while FIG. 3C may discarding as unlikely to contain human trafficking. Alternatively or additionally, the web site of FIG. 3C may be identified as suspicious of containing human trafficking while FIG. 3B may discarding as unlikely to contain human trafficking.

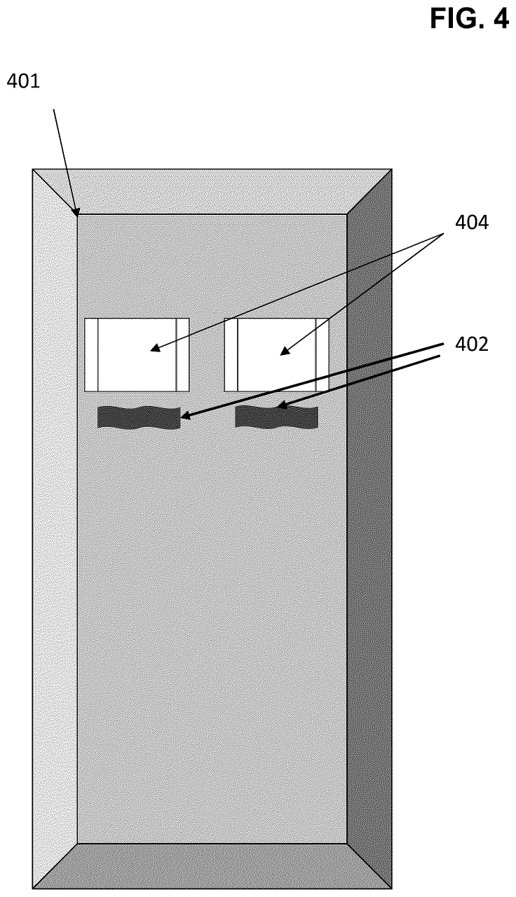

FIG. 4 is a schematic diagram illustrating a social media in accordance with an embodiment of the current invention. An embodiment may include a method and/or program for searching the content of a mobile device 401 and/or a computer. There may be included a way to check files and/or programs and/or user history on the mobile device. For example, an embodiment may be used to search and/or analyze text 402 and/or media 404 on a confiscated device and/or with permission to search from a judicial body and/or may be used while hacking into an external device.

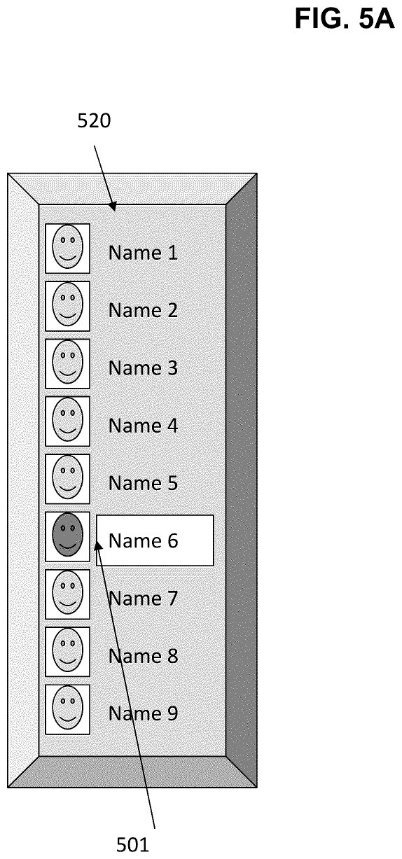

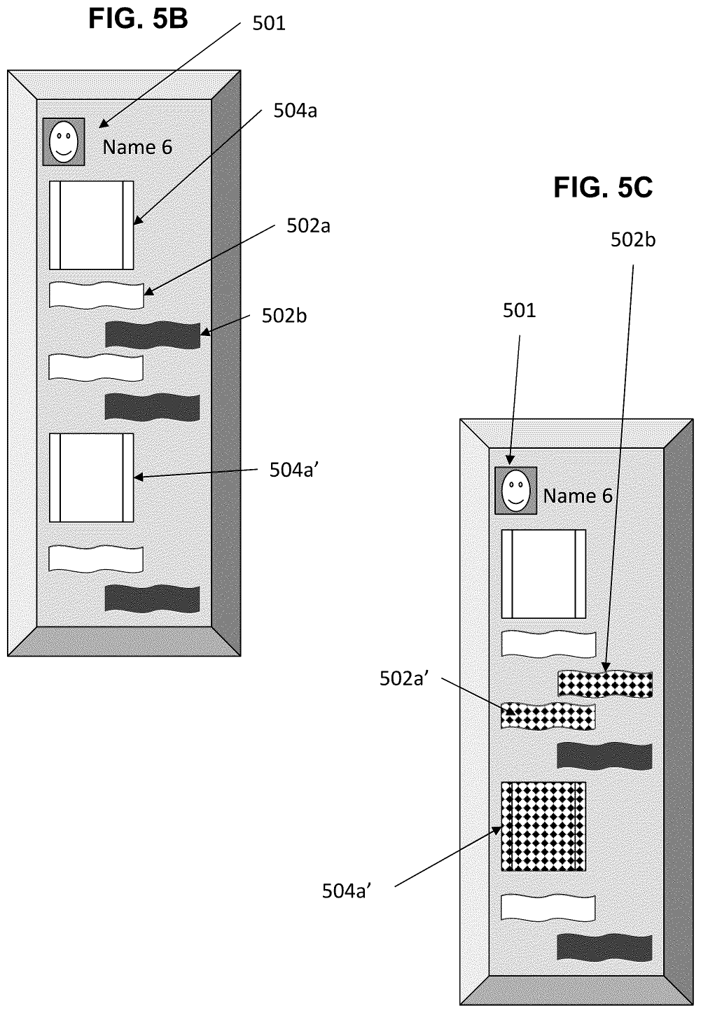

FIG. 5A is a schematic diagram illustrating an embodiment of the current invention. An embodiment may include a program and/or method for searching chat applications 520 and/or chat conversations on a phone and/or computer. A program may include a way to analyze if a certain conversation and/or identify contacts involved in suspicious communications. The system may associate between chats and/or text in chats and/or associated a user 501 and/or associated content and/or associated web resources.

FIGS. 5B and 5C illustrate chats in social networks in accordance with an embodiment of the current invention. In some embodiments, a system may identify illegal activity (e.g., human trafficking) in a social network (e.g., a chat application 520). of identifying content may identify a social network user 501 as suspicious based on links and/or associate the text in a chat with links and/or associate text on a chat with media on the chat. between and a link and/or text and/or media between communicating individuals and/or within a communication.

In some embodiments, a conversation between two users may include text 502a, 502b and/or media 504a, 504a′ from one or more users. For example, the conversation may contain text 502b that is slightly suspicious, but would not be reported in and of itself. Optionally, the relationship of the of the text 502b to the rest of the conversation may lead to the conversation being flagged and/or reported as suspicious. For example, text 502b may be nominally as response to text 502a, but lack clear connection. The presence of a suspicious content that does not fit in the context of the rest of the conversation may arouse a report.

In some embodiments, in a conversation that seems otherwise innocuous, a text 502b that is slightly suspicious and/or out of context may illicit a response that is also suspicious and/or out of context (e.g., a suspicious text 502a′ and/or a suspicious media 504a′) may be flagged as suspicious and/or reported whereas if the suspicious content were more fitting of the rest of the content and/or were not specifically associated with a suspicious response, the conversation may not have been reported.

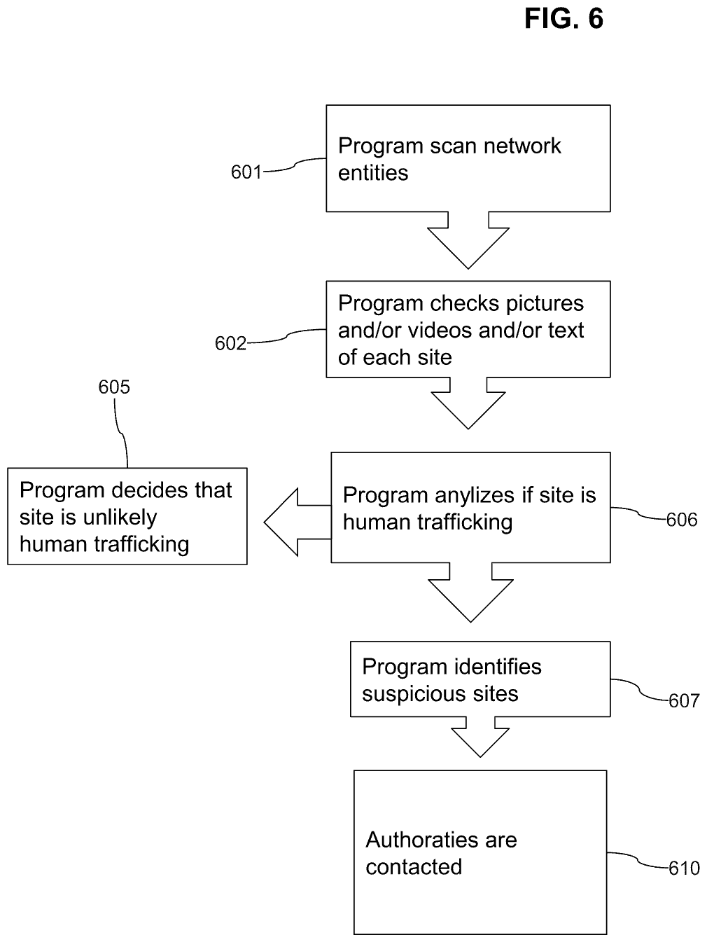

FIG. 6 is a flow chart illustrating an embodiment of the current invention. A program may scan 601 various network entities, for example, websites and/or chat participants and/or internet platforms. Optionally, entities that are not likely to be part of illegal activity are discarded. Program may check 602 pictures and/or video and/or audio and/or texts. For example, a preprocessor may collect up pertinent data and/or send relative data to analysis routines and/or discard irrelevant data. Additionally or alternatively, preprocessor may process and/or filter the data. In some embodiments, the preprocessor may use relationships between text and media, for example, based on a caption, the preprocessor may discard and/or commit fewer sources to the picture associated with the caption. Optionally the program may analyze 606 the data and/or the combinations of some and/or all of the above. Optionally, the system may identify 607 suspicious entities. In some cases, analysis may be of part of the data (e.g., just text and/or just media) and/or use low resource tools. For example, with low resource tools the system may identify 607 and/or discard 605 obvious cases. Alternatively or additionally, more sophisticated analysis 606 may be used for example using integrated analysis of text and media and/or using AI and/or using NLP etc. The program may determine a conclusion and/or an action that needs to be taken (for example, further investigation, contacting authorities 610, no further investigation (e.g., the entity may be discarded 605) and/or highly likely to be an illegal site etc.).

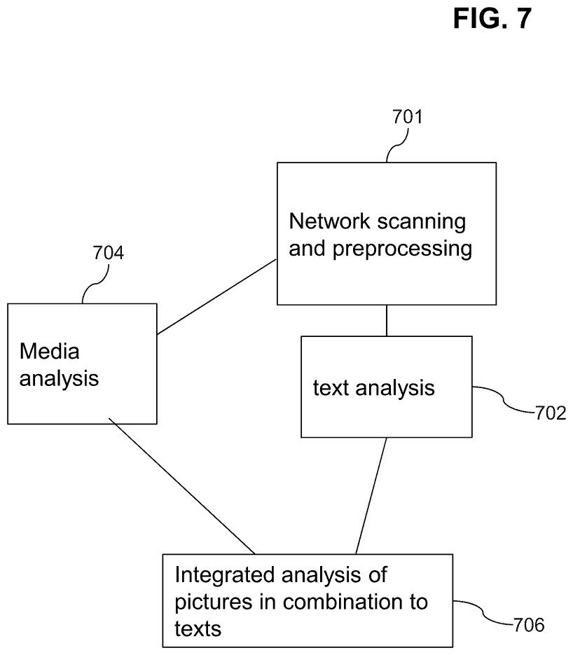

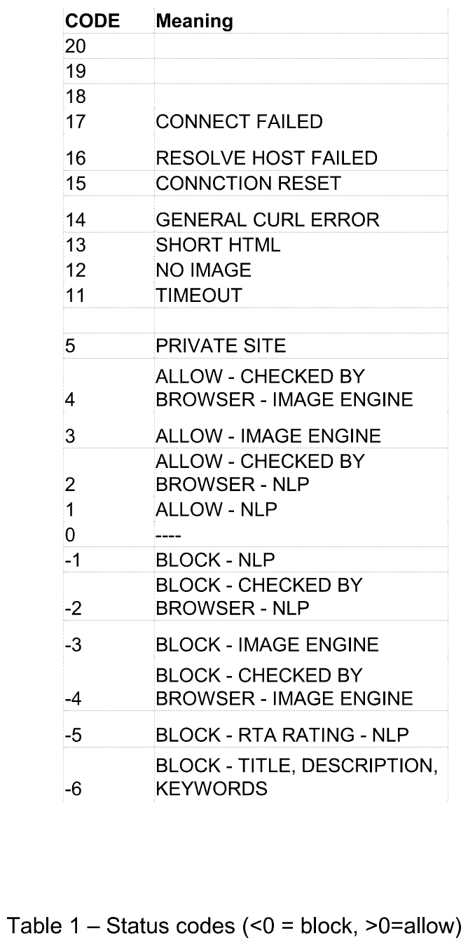

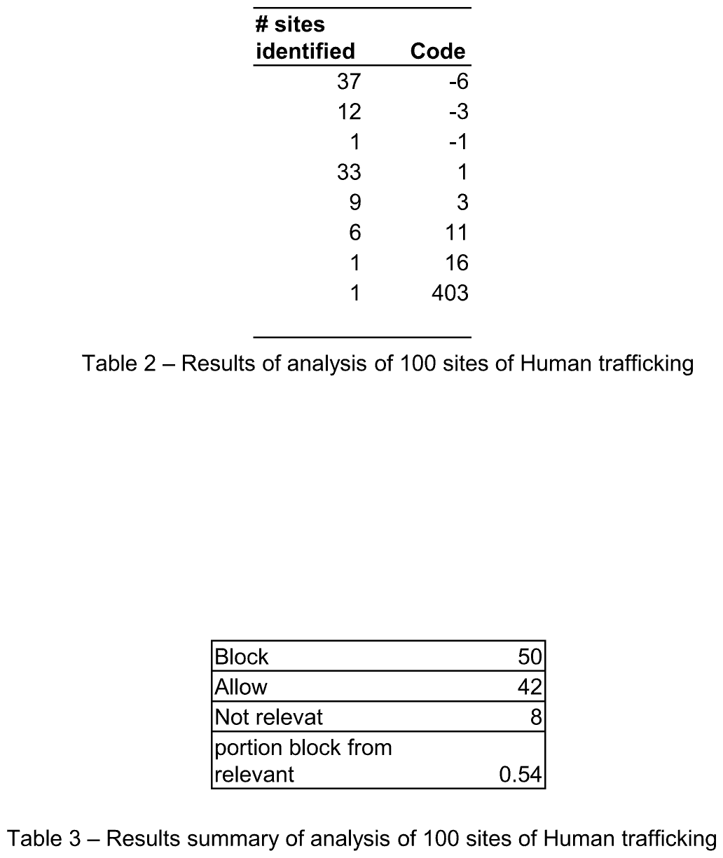

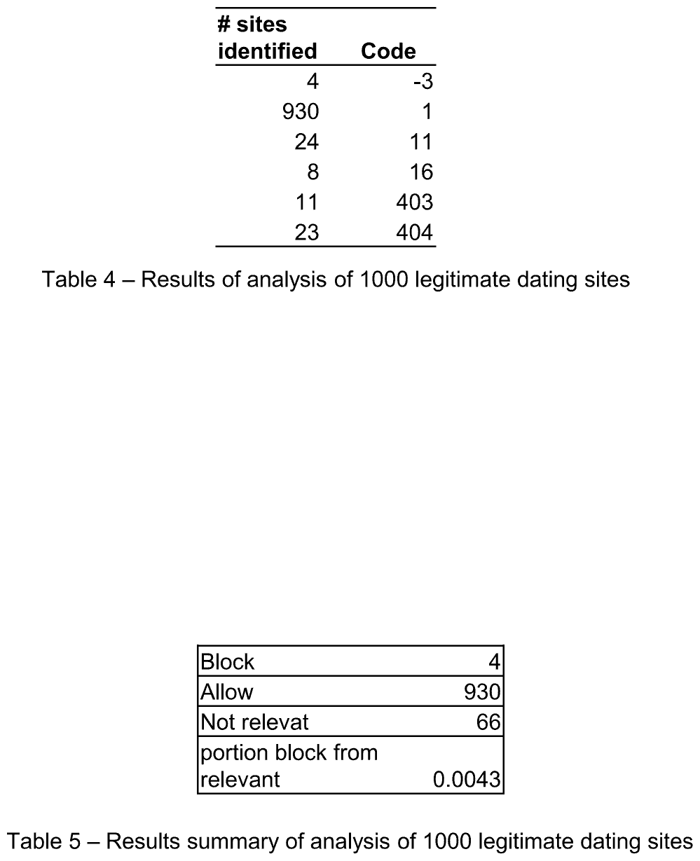

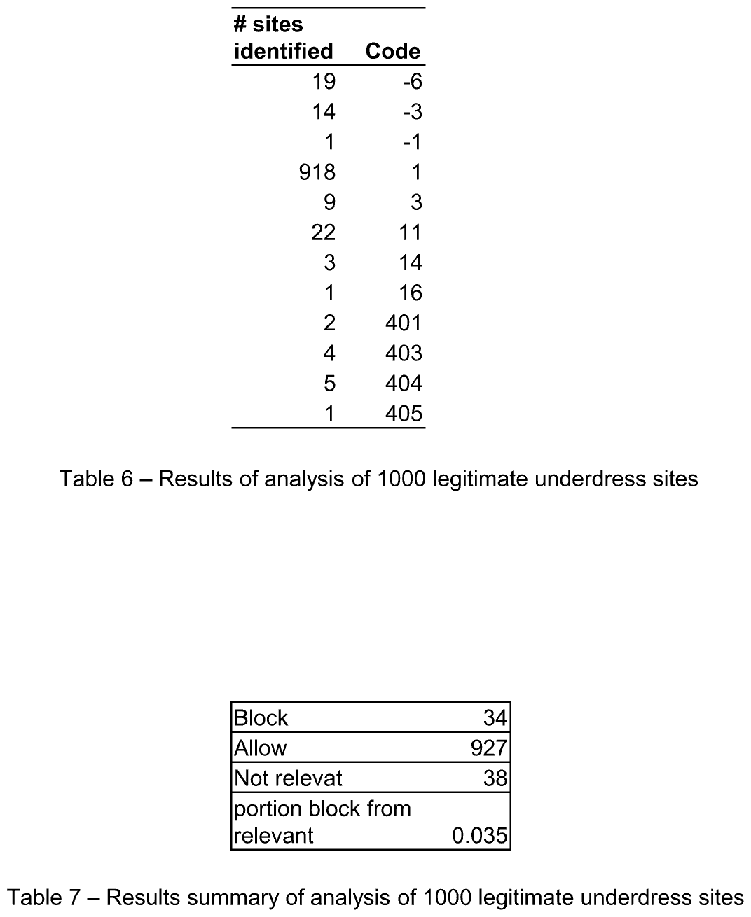

FIG. 7 is a block diagram illustrating data flow in an embodiment of the current invention. An embodiment may include a network scanner and/or a preprocessing program that extracts and/or preprocesses 701 data from network entities being analyzed. Optionally, relevant media is extracted, filtered and/or preprocessed 701 and sent to media analysis 704. Optionally, relevant text is extracted, filtered and/or preprocessed 701 and sent to a text analysis 702 and/or other media analysis function. A program may include algorithms to examine combinations of media forms to determine how much suspicion of illegal activity the web platform arouses. Optionally, the system may perform integrated analysis 706 on text and media to make more precise identification and/or eliminate suspicion of a site.

There are many ways in which the relationship between text and media and/or between different types of media and/or between various objects and/or their interrelationship may impinge on identification of an entity as illegal and/or human trafficking. For example, anachronistic text and/or media may be a sign that an entity is hiding its true function and/or serving an illegal function. For example, if an entity includes text say “help in university physics,” “tutor for Spanish,” “baby sitter,” but picture clearly suggestive of human trafficking (i.e., are sexually suggestive). For example, a page advertising a vacation in Thailand with pictures of ski lodges and/or a page advertising skiing vacation with pictures of women in beach attire and/or text advertising a high price hotel with pictures of seedy building and/or anachronistic groupings of people such as images of adult men and children or young women with text advertising escort service would arouse suspicion. In some cases, an entity may include legitimate pages selling real items, but some pages of the entity include anachronistic elements (e.g., contradictory to the legitimate sale pages and/or self-contradictory within the page itself) which would arouse suspicion.

In some cases, a web site that is improperly categorized arouses suspicion. For example, a site with pornographic images that does not advertise/title itself as pornography.

In some cases, a page may be cleared of suspicion due to a missing element. For example, there may be a combination that if X is found on a trafficking site-Y would also be expected. If X is found on a suspicious site, but not Y then the site may be cleared and/or not reported.

In some cases, a page may be identified as suspicion due to a missing element. For example, there may be a combination that if X is found in a legitimate site Y should also be (e.g., if pictures of underwear expect men/women/children separate). If the expected material is not found then the page may be rated as suspicious. For example, a Similarly, a page may be rated as suspicious and/or cleared of suspicion due to the presence and/or absence of expected links, unexpected links (forward [what advertised on site, what referenced]) (backward [where does the site advertise, who references the site)]. For example, a chat is which inquiries receive responses that don't seem to fit the inquiry may be assigned a higher suspicion level.

In some cases, an anachronym may be geographic. For example, a site may be found suspicious if images and/or text show geographic inconsistency. For example, if a site includes text that appears to be a legitimate escort service, one would expect geographic consistency [i.e., the images should be local to the company]. If there are a lot of pictures of women in other countries then the site may be found suspicious. Similarly, if a site advertising women's clothing includes pictures of women in third world countries in traditional dress it may arouse suspicion.

In some embodiments, an anachronism may include inappropriate dress. For example, a site includes text advertising babysitting it would not be expected to include pictures of people in sexually suggestive and/or revealing dress and/or a site including text advertising clothing would not be expected to include pictures of impoverished people poorly dressed and/or people in traditional dress.

In some embodiments, an anachronism may include climatic inconsistencies. For example, a page advertising skiing vacations would not be expected to show pictures of people outdoors in revealing dress. An escort service and/or a car rental site in New York would not be expected to include pictures of a palm trees.

In some embodiments, an anachronism may include inappropriate aged people. For example, a site having text that advertises drugs and/or products for adults would not be expected to have a lot of pictures of younger people in suggestive dress.

### General

It is expected that during the life of a patent maturing from this application many relevant building technologies, artificial intelligence methodologies, computer user interfaces, image capture devices will be developed and the scope of the terms for design elements, analysis routines, user devices is intended to include all such new technologies a priori.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

As used herein the term “about” refers to ±10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non limiting fashion.

In a test of an embodiment of the current invention a database was compiled including 100 web sites identified as containing human trafficking (after human review of each site). Additionally, the database included 1000 dating sites not including human trafficking and 1000 sites not including human trafficking, but including lingerie and underclothes.

A program was used to test all of the sites to identify human trafficking.

Table 1 illustrates the possible results of the program. Positive result codes meant that the site was allowed as likely free of human trafficking, negative codes meant that the site was identified as a likely site of human trafficking and/or blocked. The system went from quick easy tests to more complicated and difficult tests. The idea was to classify sites where possible with simple routines and avoid more expensive checks. The system first took text from the site and checked the text for signs of human trafficking. If the text was highly indicatory of human trafficking, then the site was given a code of −6 and blocked. If the text didn't give a clear enough indication of human trafficking, then the site was checked by analyzing media (images). If the images indicated a high probability that the site included human trafficking, then the return code −5, −4 or −3 was assigned and/or the site slated for blocking. If the images and the text indicated that the site was very unlikely to contain human trafficking, then site assigned a return code of 3 or 4 and/or allowed. When separate text and image analysis did not lead to a clear conclusion, the site was further checked using a Natural Language Processing (NLP) Artificial Intelligence (IA) routine. When the NLP routine determined the site likely to contain human trafficking then the site was assigned a result code −1 or −2 and/or blocked. When the NLP routine determined that the site was unlikely to contain human trafficking, it was assigned a result code of 1 or 2 and allowed.

The result of the exemplary case of previously identified human trafficking sites are shown in table 2 and table 3. The system succeeded in identifying approximately half of the human trafficking sites. The simple text routine was reasonably successful at recognizing trafficking sites (33/100). The image analysis was able to catch an additional 12 site. The NLP routine was set relatively low sensitivity and only identified one site that was not identified by the simpler routines. All in all, the system was not able to test 8 of sites and correctly identified 50 of the 92 tested sites making a successful identification rate of 54%

Table 4 and table 5 show the results for the 1000 dating sites not including human trafficking. As can be seen neither the text analysis alone nor the figure analysis alone were able to come to a clear conclusion that the dating sites did not contain human trafficking (there are no sites that were given result codes 3 or 4). In fact, the image analysis incorrectly identified 4 of the sites as pertaining to human traffic (output code −3). By AI analysis integrating both text and image data correctly identified the vast majority (930 of 934 [1000 sites-66 sites not tested] sites tested) as not being related to human trafficking. The AI engine did not err in identifying any of the clean dating sites as human trafficking (which would have been a result of −1 or −2).

Table 6 and table 7 show the results for the 1000 sites related to underclothing not including human trafficking. As can be seen the text analysis alone was not able to come to a clear conclusion that the clothing sites did not contain human trafficking. Image analysis was able to conclude that 9 of the 1000 site were free of human trafficking (there are 9 sites with a result code 3). By using AI analysis, the vast majority (918 of 962 [1000 sites-38 sites not tested] sites tested) were recognized as not being related to human trafficking.

The results point to a very surprising ability of integrated analysis of media (images) together with text to make the recognition of human highly specific with little or no loss of sensitivity.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method for categorizing an entity with respect to a sought content comprising:
analyzing text in the entity to produce a text analysis;
analyzing media in the entity to produce a media analysis;
correlating said text analysis and said media analysis; and
classifying whether the entity includes the sought content based said correlating.

2. The method of claim 1, wherein said sought content is human trafficking.

3. The method of claim 1, wherein said classifying is based on an artificial intelligence routine.

4. The method of claim 3, wherein said artificial intelligence routine include natural language analysis.

5. The method of claim 1, further comprising analyzing text of includes of a second entity classifying said second entity as unlikely to include the sought content based on said text analysis without preforming said correlating.

6. The method of claim 1, wherein said correlating includes correlating a portion of the text in the entity with a media associated with the portion of the text.

7. The method of claim 1, wherein a site is identified as suspicious due to a presence of anachronistic material.

8. The method of claim 7, wherein said anachronistic material includes geographically anachronistic material.

9. The method of claim 7, wherein said anachronistic material includes climatically anachronistic material.

10. The method of claim 7, wherein said anachronistic material includes inappropriate dress.

11. The method of claim 7, wherein said anachronistic material includes inappropriate aged people.

12. The method of claim 7, wherein said anachronistic material includes inappropriate groupings of people.

13. The method of claim 1, wherein an entity is identified as suspicious due to lacking an expected element.

14. The method of claim 1, wherein an entity is cleared of suspicion due to lacking an expected element.

15. The method of claim 1, wherein an entity is identified as suspicious due to lacking an expected forward link.

16. The method of claim 1, wherein an entity is cleared of suspicion due to lacking an expected forward link.

17. The method of claim 1, wherein an entity is identified as suspicious due to lacking an expected backward link.

18. The method of claim 1, further comprising preprocessing the entity to discard elements that are unlikely to be relevant to the analysis. 19 The method of claim 1,
wherein the analyzing accounts for a hierarchy of the entity.

19. The method of claim 1, wherein the entity includes a chat user.

20. The method of claim 1, wherein the entity includes a website.

21. The method of claim 1, wherein the entity includes a web page.

22. The method of claim 1, wherein the entity includes a chat application.
